(19) United States
(12) Patent Application Publication
(10) Pub. No.: US 2013/0278055 A1
(43) Pub. Date: Oct. 24, 2013

(54) MOTOR VEHICLE ELECTRICAL SYSTEM HAVING SUBSYSTEMS AND A GENERATOR SYSTEM, GENERATOR SYSTEM AND METHOD FOR OPERATING A VEHICLE ELECTRICAL SYSTEM

(71) Applicants: Ralf Herbig, Leonberg (DE); Marc Eschenhagen, Ludwigsburg (DE)

(72) Inventors: Ralf Herbig, Leonberg (DE); Marc Eschenhagen, Ludwigsburg (DE)

(73) Assignee: ROBERT BOSCH GMBH, Stuttgart (DE)

(21) Appl. No.: 13/865,723

(22) Filed: Apr. 18, 2013

(30) Foreign Application Priority Data
Apr. 20, 2012 (DE) 10 2012 206 583.0
May 30, 2012 (DE) 10 2012 209 076.2
Jun. 12, 2012 (DE) 10 2012 209 829.1

(51) Int. Cl. B60R 16/03

(52) U.S. Cl. CPC B60R 16/03
USPC 307/10.1

(57) ABSTRACT

A motor vehicle electrical system includes at least one first subsystem and one second subsystem having different voltage levels. The first subsystem has a generator system, which is designed to supply the first subsystem with a first subsystem voltage, the generator system having an electrically excited generator including an exciter winding and a generator governor for controlling the exciter winding. The exciter winding is connected to the second subsystem and supplied with a second subsystem voltage from the second subsystem.

### BACKGROUND OF THE INVENTION

1. Field of the Invention

The present invention relates to a motor vehicle electrical system having at least two subsystems and having a generator system feeding one of the subsystems, a corresponding generator system and a method for operating a corresponding vehicle electrical system.

2. Description of the Related Art

Electric machines operable as generators may be used to provide electrical energy in motor vehicles. In the process, a driving torque is transmitted via a mechanical connection between the internal combustion engine and the electric machine and is generated by the internal combustion engine. So-called claw pole generators are mostly used as electric machines. These may be equipped with a rotor winding (exciter winding) and a stator winding.

Since claw pole generators normally produce three-phase alternating current, a power rectification is required for the d.c. voltage electrical systems that normally exist in motor vehicles.

Often the mentioned electric machines are also coupled to a generator governor (field governor), which is supplied from the host's generator voltage or from an existing energy store, e.g. the battery of the vehicle electrical system. For this purpose, controllers may be used, e.g. in the form of integrated circuits having power electronics, which set the current required in the vehicle's electrical system in accordance with the requirements of the electrical consumers and the battery charging strategy. In the process, the vehicle system voltage is used as a controlled variable and is permanently adjusted to a setpoint voltage.

In the context of the present application, the term “generator system” is used for a corresponding electric machine and an associated generator governor and a corresponding rectifier. In this connection, however, it should be noted that a corresponding generator system may also be operable as a motor.

Motor vehicle electrical systems may be developed in the form of so-called two-voltage and multi-voltage vehicle electrical systems having at least two subsystems. Such electrical systems are used for example when consumers having different power requirements exist in a particular motor vehicle. In this case, at least two of the subsystems have different voltage levels, e.g. 14 V (a so-called low-voltage subsystem) and 48 V (a so-called high-voltage subsystem). The subsystems may be connected to each other e.g. via a d.c. voltage converter. At least one of the subsystems has a generator system that feeds the subsystem. A second or additional subsystem connected via said d.c. voltage converter may then in turn be supplied from the subsystem having the generator system.

The present invention aims to improve the supply of power to motor vehicle electrical systems having at least two subsystems using a generator system.

### BRIEF SUMMARY OF THE INVENTION

The present invention provides an advantageous system architecture for a generator system in a two- or multi-voltage vehicle electrical system, in particular a vehicle electrical system having more than one energy store. The motor vehicle electrical system has at least two subsystems having different voltage levels, a first subsystem being fed by a generator system, the generator governor of the generator system however being supplied from another, second subsystem. The second subsystem preferably has an energy store that advantageously makes it possible to supply the generator governor even when the first subsystem is without current.

The controlled variable of the generator governor is advantageously a voltage produced by the generator system itself, that is, the voltage of the first subsystem.

For this purpose, the present invention advantageously includes the use of a claw pole generator, which is operated for generating a voltage, which is above the regular vehicle system voltage of e.g. 14 V and below a maximum admissible touch voltage of 60 V. Such a generator system advantageously feeds a high-voltage subsystem of a two- or multi-voltage vehicle electrical system. Thus, in a two-voltage vehicle electrical system having two subsystems, which are set up for operation at 14 V on the one hand and at 48 V on the other hand, the generator is situated in the 48 V subsystem.

In other words, the present invention provides for a partitioning of a generator governor in a multi-voltage system. For this purpose, an advantageous generator system has a standard generator governor circuit (“field governor”), e.g. a corresponding ASIC, having adapted detection inputs developed for detecting the higher generator output voltage. Another reason why the present invention is especially advantageous is that there is no requirement for different ground points on the generator governor ASIC. This allows for a cost-effective implementation.

On account of the measures of the present invention, the generator governor is at the same voltage level as a communication (COM) interface of the generator system (e.g. for controlling by an engine control unit), which in conventional multi-voltage vehicle electrical systems is at the lower voltage level. This prevents an introduction of overvoltages into a communication line connected to the communication interface even when a ground connection of the generator governor is eliminated. This makes it possible reliably to avoid a fault or damage in a communication bus or other components without further expenditure.

The present invention furthermore allows for the exciter winding or the corresponding exciter circuit to be supplied even when a subsystem voltage in the subsystem that is fed by the generator system is no longer supplied. This may be the case, for example, in the event of a discharged energy store in a corresponding subsystem and/or in the event of a switched-off supply battery.

Electrical machines in a vehicle electrical system, that is, e.g. the generator system in a high-voltage subsystem and a starter motor in a low voltage subsystem, are for constructional reasons normally connected via their housing to the engine block of the internal combustion engine in a conductive and permanent manner. The engine block represents the ground connection for the electrical machines. At the same time, the two energy stores, that is, a high-voltage battery or a corresponding capacitor and a low-voltage battery, are integrated by their positive poles into the respective subsystems and are connected by their negative poles to the chassis as ground. The consumers in the low-voltage subsystem are also grounded via the chassis. An exciter winding of a generator system, which like its generator is integrated into a high-voltage system, in the activated state and when the generator is at a standstill, establishes a connection between the voltage-side and the ground-side generator terminal.

In order to relate the engine block and the chassis to the same ground potential and additionally absorb the different mechanical movements, these are connected e.g. via a ground strap. If this ground connection is interrupted as a result of a fault, then in this case a conductive exciter winding may effect a polarity reversal of the components in the low-voltage subsystem. As explained in more detail below, this may be reliable prevented by the present invention without additional constructional expenditure.

By supplying power to the exciter winding at a lower voltage, it is possible to develop the contact spacings with respect to cross line and electric arc in smaller dimensions. The electric strength of the components may also be reduced such that cost advantages are achieved. Moreover, a reduced closed current is achieved as compared to conventional generator systems.

### BRIEF DESCRIPTION OF THE DRAWINGS

FIG. 1 shows a schematic representation of a two-voltage vehicle electrical system that is not designed according to the present invention.

FIG. 2 shows a schematic representation of a two-voltage vehicle electrical system according to one specific embodiment of the present invention.

FIG. 3 shows a schematic representation of a generator system that is not designed according to the present invention.

FIG. 4 shows a schematic representation of a generator system according to one specific embodiment of the present invention.

### DETAILED DESCRIPTION OF THE INVENTION

The figures indicate elements corresponding to one another by identical reference symbols, which are not explained repeatedly.

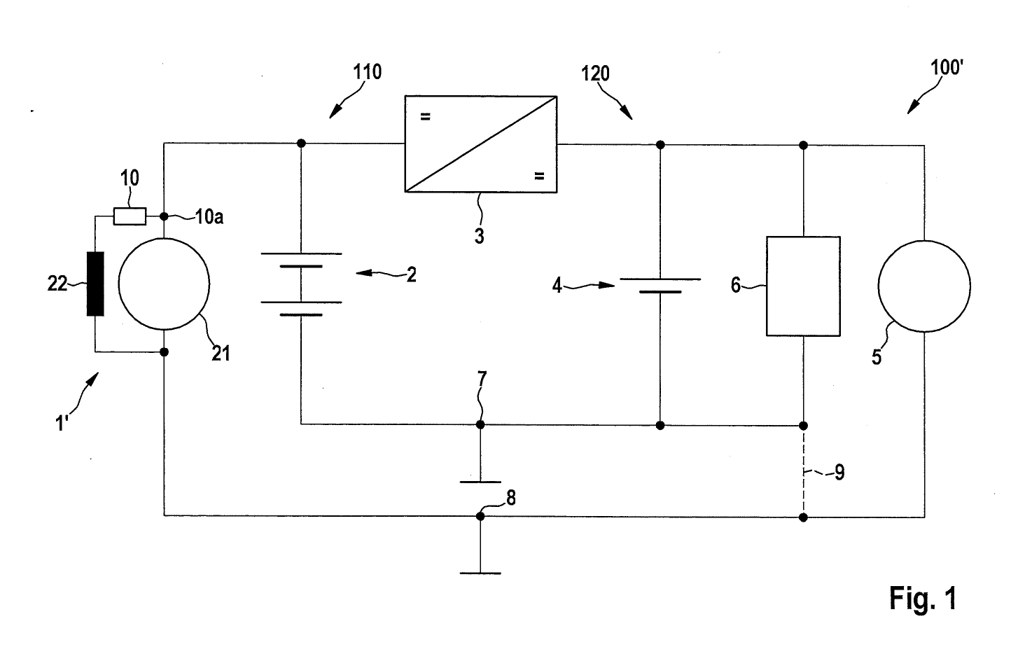

FIG. 1 shows a two-voltage vehicle electrical system, which is not designed according to the present invention, and denotes this as a whole by reference numeral 100′. The two-voltage vehicle electrical system 100′ has two subsystems 110 and 120, which are preferably developed to be operated at different voltage levels. As explained, the present invention may also be advantageously used in multi-voltage vehicle electrical systems having more than two subsystems 110 and 120.

First subsystem 110 has a generator system 1′ including an electrical machine having a stator winding 21 and an exciter winding 22. Exciter winding 22 is supplied with current by a generator governor 10, preferably in a clocked manner. Generator governor 10 is supplied via a terminal 10a from the same subsystem 110, in which generator system 1′ is situated. In two-voltage vehicle electrical system 100′, first subsystem 110 may be developed as a high-voltage subsystem and second subsystem 120 may be developed as a low-voltage subsystem. Subsystems 110 and 120 may be operated at 48 V (or e.g. 42 V) on the one hand and at 14 V on the other hand.

The electric machine may be developed for example as a claw pole generator. It is designed to feed a subsystem voltage into first subsystem 110 when it is operated as a generator.

In first subsystem 110, a first energy store 2 is provided, for example an appropriately designed battery or a suitable double-layer capacitor, in order to store an electrical energy fed by generator system 1′ into first subsystem 110.

First subsystem 110 and second subsystem 120 are connected to each other by a d.c. voltage converter (DC/DC converter) 3. D.c. voltage converter 3 is preferably developed as a bidirectional converter and is thus designed to convert a (higher) subsystem voltage of the first subsystem 110 into a (lower) subsystem voltage of the second subsystem 120 and vice versa. D.c. voltage converter 3, however, may also be developed as a unidirectional converter. D.c. voltage converter 3 advantageously has active switch elements and is controllable accordingly.

An energy store 4, for example a vehicle battery, is likewise provided in second subsystem 120. Second subsystem 120 furthermore includes for example an electric machine 5 in the form of a starter motor. Consumers 6, which are shown here only schematically, are integrated into the second subsystem and are designed to be operated at the subsystem voltage of second subsystem 120, e.g. 14 V.

Generator system 1′ is designed to feed subsystem 110. Second subsystem 120 may be supplied from first subsystem 110 via d.c. voltage converter 3.

Since generator governor 10 feeds exciter winding 22 with the subsystem voltage from first subsystem 110, the exciter winding can only be excited either when a sufficient voltage is available in energy store 2 or when such sufficient voltage may be provided from second subsystem 120 via d.c. voltage converter 3.

Energy stores 2, 4 of the two subsystems 110 and 120 are furthermore connected on the ground side (or by their negative poles) to a chassis terminal 7 and supply subsystems 110 and 120 via their respective positive poles. Consumers 6 in second subsystem 120 are also connected on their ground side to chassis terminal 7. For constructional reasons, as already explained, there exists on the other hand a ground-side connection of generator system 1′ and electric machine 5 to an engine block, represented here as engine block terminal 8. Chassis terminal 7 and engine block terminal 8 are in turn conductively connected to each other via a so-called ground strap 9. Ground strap 9 acts as a reverse-polarity protection so as to relate the engine block and the chassis to the same ground potential.

This protection against polarity reversal prevents a polarity reversal of consumers 6 in second subsystem 120 if the latter is developed as a low-voltage system and first subsystem 110 is developed as a high-voltage system. If ground strap 9 is interrupted, then the electric machine of generator system 1′ is at a standstill, and if exciter winding 22 is activated by generator governor 10, then a polarity reversal of consumers 6 may occur in second subsystem 120.

In this case, a fault current flows from the positive pole of energy store 2, which is developed e.g. as a high-voltage battery, via terminal 10a, through (conductively switched) exciter winding 22, (non-grounded) engine block terminal 8, a likewise conductive exciter winding of electric machine 8 and via consumer 6 to ground (in the form of chassis terminal 7). In the process, a reverse polarity voltage of 48−14=34 V is applied to consumer 6. This can damage consumer 6.

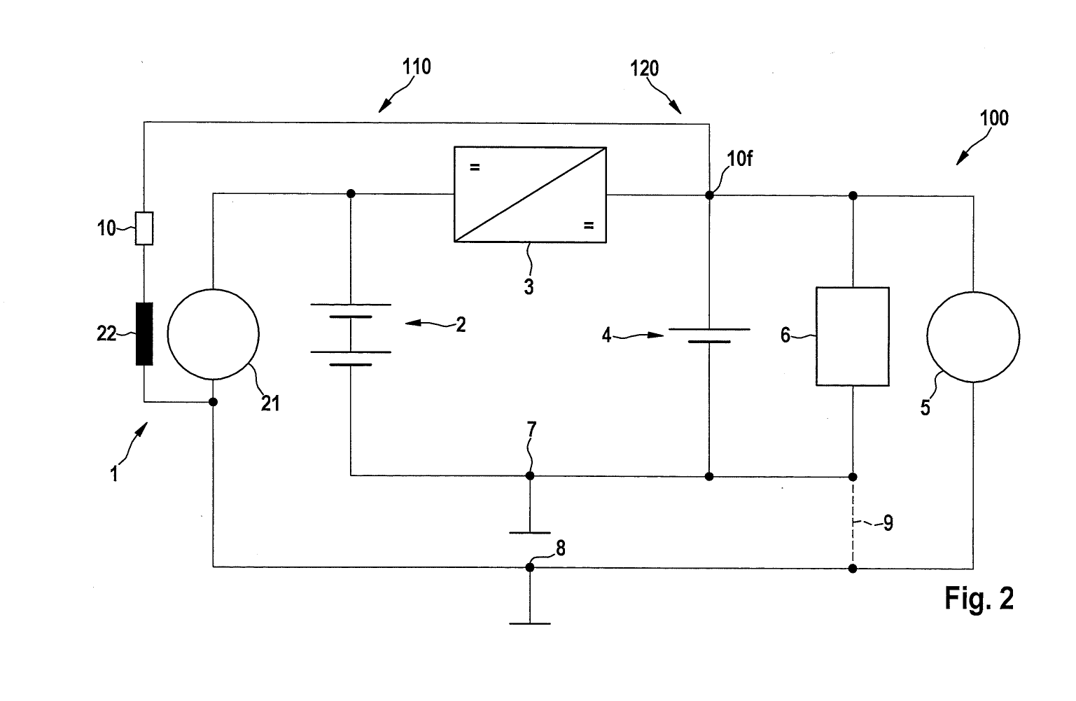

FIG. 2 shows a two-voltage vehicle electrical system according to a preferred specific embodiment of the present invention, which is indicated as a whole by reference numeral 100. The represented two-voltage vehicle electrical system 100 also has two subsystems 110 and 120 and the essential components of the previously described two-voltage vehicle electrical system 100′. As explained, the present invention may also be advantageously used in multi-voltage vehicle electrical systems having more than two subsystems 110 and 120.

In contrast to the previously described two-voltage vehicle electrical system 100′, the exciter winding 22 of the generator system indicated here by 1, however, is fed via generator governor 10 from second subsystem 120.

As was explained, this is advantageous for various reasons. Thus exciter winding 22 may be excited even when energy store 2 in first subsystem 110 is discharged and no voltage can be supplied via d.c. voltage converter 3 from the second subsystem. Energy store 4 in second subsystem 120 is normally developed as a regular vehicle battery that has a long operating time compared to energy store 2 in first subsystem 110 such that exciter winding 22 may always be powered reliably by generator governor 10.

On the other hand, even when ground strap 9 is interrupted, no current is able to flow from energy store 2 in first subsystem 110 via exciter winding 22 into second subsystem 120 and reverse the polarity of the respective consumers.

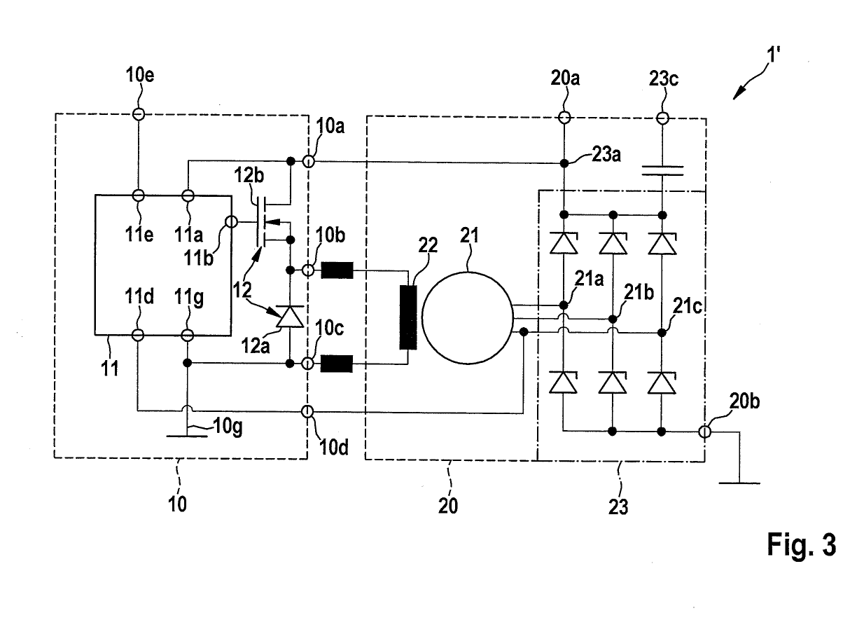

FIG. 3 again shows a generator system, which is not designed according to the present invention, and denotes this as a whole by reference numeral 1′. Generator system 1′ may be operated at least as a generator and includes a generator governor 10 and an electric machine 20. Generator governor 10 and electric machine 20 are situated in housings respectively represented by dashed lines. Generator governor 10 has a control circuit 11, e.g. an ASIC.

Electric machine 20 has a schematically indicated stator winding 21 and an exciter winding 22. A rectifier circuit 23 is shown as another component of electric machine 20. This may be constructed in a known manner and is developed to rectify phase voltages applied on terminals 21a through 21c of stator winding 21 using known rectifier elements (e.g. Zener diodes or active switch element, transistors). A rectified output voltage is applied on terminals 20a and 23a, respectively, and is fed e.g. into a first subsystem 110. One terminal 20b has a connection to ground. Terminal 23a may also be connected to a housing terminal 23c, and thus to ground, via an interposed and appropriately designed capacitor. This improves electromagnetic compatibility.

Generator system 1′ may be integrated e.g. into the vehicle electrical system 100′ that is shown in FIG. 1.

Generator governor 10 has terminals 10a through 10e. A first terminal 10a acts as a supply terminal for generator governor 10 and is supplied with a voltage generated by electric machine 1′, e.g. 48 V, via output 23a of rectifier circuit 23.

Control circuit 11 provided in generator governor 10 is designed to supply current to exciter winding 22 by activating a current supply unit 12. Current supply unit 12 has e.g. a diode 12a and an active switch element 12b. Exciter winding 22 may thereby be supplied with current, preferably in a clocked manner, via control circuit 11 at the voltage of the generator output provided via first terminal 10a, e.g. at 48 V.

Control circuit 11 and current supply unit 12 are preferably designed to set a current flowing through exciter winding 22, for example by pulse width modulation (PWM). Exciter winding 22 is connected to the generator governor via terminals 10b and 10c. Active switch element 12b is controlled via a controller output 11b.

For its controlling action, control circuit 11 receives at least one phase signal of electric machine 20 via another terminal 11d. Terminal 11d is developed as a detector terminal and is connected to a corresponding terminal 10d in the housing. A rectified output voltage of generator 21 is detected by evaluating the voltage on the described terminal 11d. The latter may also be used to provide a supply voltage for control circuit 11.

Control circuit 11 is connected to a ground terminal 10g via another terminal 11g, as explained, for example to an engine block terminal 8. The same applies to exciter winding 22. Control circuit 11 may be connected via a controller input 11e to a communication terminal 10e and may be controlled via the latter for example by a control unit (not shown).

Communication terminal 10e, and thus also controller input 11e, are at the same voltage level as a controlling control unit and e.g. a system bus. Control circuit 11, however, is operated via controller input 11a at the voltage produced by the generator, which is applied on terminals 10a and 23a. As mentioned, the generator supplies a subsystem of a higher voltage. The voltage applied on terminals 10a and 23a is therefore higher than the voltage possibly applied on terminals 10e and 11e (48 V compared to 14 V). If ground connection 10g is interrupted by a fault, the differential voltage of 34 V is therefore able to flow off in an undesired way via communications terminal 10e. This effects a polarity reversal/overvoltage in the components connected to communication terminal 10e, e.g. a system bus and a control unit. These may be damaged thereby.

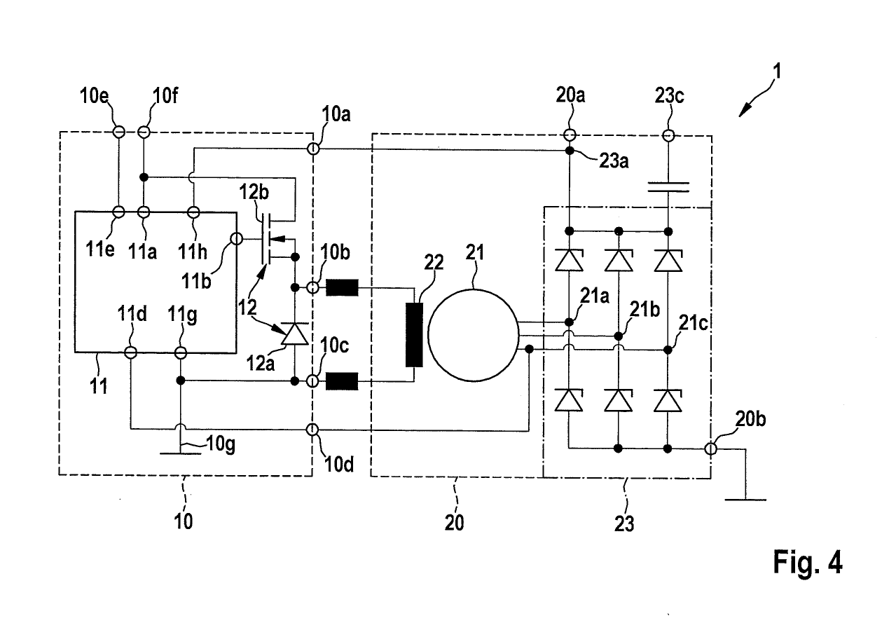

FIG. 4 shows a generator system according to a specific embodiment of the present invention, which is indicated as a whole by reference numeral 1. It may be integrated for example into a vehicle electrical system 100 shown in FIG. 2.

In contrast to the system shown in FIG. 3, exciter winding in this case is supplied via an additional terminal 10f, which is connected for example to a second subsystem 120, e.g. a low-voltage system, and thus receives an accordingly lower voltage than is produced by electric machine 20, which is controlled by generator governor 10. For this purpose, terminal 10f is able to be connected to exciter winding 22 via active switch element 12b of current supply unit 12, preferably in a clocked manner. As also shown previously in FIG. 3, control circuit 11 is supplied via a terminal 11a, yet at an accordingly lower voltage. This voltage may also be evaluated on terminal 11a for example in order to supply appropriate current to exciter winding 22 by accordingly adapting the clocking of active switch element 12b of current supply unit 12 to it.

Via a terminal 11h, there furthermore exists a connection to terminal 10a or output 23a of the electric machine (that is, first subsystem 110). Terminal 11h is developed as a pure detection terminal, however, control circuit 11 and/or exciter winding 22 not being supplied via terminal 11h. An overvoltage may be prevented for example by an electrical isolation of a detection circuit connected to terminal 11h in control circuit 11.

Communication terminal 10e, and thus also controller input 11e, as explained, is at the same voltage level as a controlling control unit. This is now also the case with respect to exciter winding 22. Overvoltages can therefore no longer occur at terminal 10e.

The described architecture is designed in such a way that a standard 14 V control circuit 11, e.g. in the form of an ASIC or μC controller or the like, may be used following a simple adaptation of phase terminal 10d and detection terminal 10a (e.g. by a simple voltage divider). Here, as explained, the supply of control circuit 11 is established via an additional terminal 10f from low-voltage subsystem 110. For a recuperation and sailing function and/or an adaptability of the vehicle electrical power, an interface controller having a standard LIN interface is required for example.

What is claimed is:

1. A motor vehicle electrical system, comprising:
at least one first subsystem and one second subsystem having different voltage levels;
wherein the first subsystem includes a generator system configured to supply the first subsystem with a first subsystem voltage, the generator system having an electrically excited generator including an exciter winding and a generator governor for controlling the exciter winding, and wherein the exciter winding is connected to the second subsystem and supplied with a second subsystem voltage from the second subsystem.

2. The motor vehicle electrical system as recited in claim 1, wherein the motor vehicle electrical system is configured as a two-voltage vehicle electrical system, the first subsystem being configured to be operated at a first subsystem voltage, and the second subsystem being configured to be operated at a second subsystem voltage, the first subsystem voltage being higher than the second subsystem voltage.

3. The motor vehicle electrical system as recited in claim 2, wherein the first subsystem and the second subsystem are connected via a DC voltage converter which at least one of (i) converts the first subsystem voltage into the second subsystem voltage, and (ii) converts the second subsystem voltage into the first subsystem voltage.

4. The motor vehicle electrical system as recited in claim 3, wherein at least one of (i) a first energy store is situated in the first subsystem, and (ii) a second energy store is situated in the second subsystem.

5. A generator system for a motor vehicle electrical system having at least one first subsystem and one second subsystem having different voltage levels, wherein the first subsystem includes a generator system configured to supply the first subsystem with a first subsystem voltage, the generator system having an electrically excited generator including an exciter winding and a generator governor for controlling the exciter winding, and wherein the exciter winding is connected to the second subsystem and supplied with a second subsystem voltage from the second subsystem, the generator system comprising:
a generator; and
a generator governor configured to detect the first subsystem voltage of the first subsystem of the motor vehicle electrical system and to supply an exciter winding of the generator with the second subsystem voltage of the second subsystem.

6. The generator system as recited in claim 5, wherein the generator governor is configured to detect at least one phase voltage on an output of the generator.

7. The generator system as recited in claim 6, wherein the generator governor is configured to feed the exciter winding of the generator on the basis of at least one of the first subsystem voltage of the first subsystem, the second subsystem voltage of the second subsystem, the phase voltage, and at least one setpoint voltage in a clocked manner.

8. The generator system as recited in claim 7, wherein the generator governor is configured to set an output voltage of the generator by feeding the exciter winding of the generator in a clocked manner.

9. The generator system as recited in claim 7, further comprising:
at least one communication terminal, wherein the generator system is controlled by a control unit via the at least one communication terminal.

10. A method for operating a motor vehicle electrical system having a generator system and at least one first subsystem and one second subsystem having different voltage levels, wherein the first subsystem includes a generator system configured to supply the first subsystem with a first subsystem voltage, the generator system having an electrically excited generator including an exciter winding and a generator governor for controlling the exciter winding, and wherein the exciter winding is connected to the second subsystem and supplied with a second subsystem voltage from the second subsystem, the generator system having a generator and a generator governor configured to detect the first subsystem voltage of the first subsystem of the motor vehicle electrical system and to supply an exciter winding of the generator with the second subsystem voltage of the second subsystem, the method comprising:
supplying, with the aid of the generator governor, the exciter winding of the generator system with the second subsystem voltage of the second subsystem; and
outputting an output voltage of the generator system to the first subsystem.

11. The method as recited in claim 10, wherein the first subsystem is operated at a setpoint voltage which is higher than a setpoint voltage of the second subsystem.

12. The method as recited in claim 11, wherein the output voltage of generator system is controlled on the basis of at least one of an actual voltage of the first subsystem, an actual voltage of the second subsystem, a phase voltage of the generator, and at least one setpoint voltage.
